(19) United States
(12) Patent Application Publication
(10) Pub. No.: US 2024/0378432 A1
(43) Pub. Date: Nov. 14, 2024

(54) MICRORING-BASED PROGRAMMABLE COHERENT OPTICAL NEURAL NETWORK

(71) Applicant: Toyota Motor Engineering & Manufacturing North America, Inc., Plano, TX (US)

(72) Inventors: Jiahui Wang, Redwood City, CA (US); Shanhui Fan, Stanford, CA (US); Sean P. Rodrigues, Ann Arbor, MI (US); Ercan Mehmet Dede, Ann Arbor, MI (US)

(73) Assignees: Toyota Motor Engineering & Manufacturing North America, Inc., Plano, TX (US); The Board of Trustees of the Leland Stanford Junior University, Stanford, CA (US); Toyota Jidosha Kabushiki Kaisha, Toyota-shi Aichi-ken (JP)

(21) Appl. No.: 18/196,226

(22) Filed: May 11, 2023

(51) Int. Cl. G06N 3/067; G02B 6/12; G06N 3/08

(52) U.S. Cl. CPC G06N 3/067; G02B 6/12007; G06N 3/08; G02B 6/29343; G02B 6/29395

(57) ABSTRACT

Systems, methods, and other embodiments described herein relate to specialized hardware accelerators for deep learning tasks. In one embodiment, a system includes a first waveguide and a second waveguide. The first waveguide is spaced from the second waveguide. The system includes a first phase tuning component, a second phase tuning component, and a signal mixing component. The first phase tuning component includes a first ring resonator that is coupled to the first waveguide. The second phase tuning component includes a second ring resonator that is coupled to the second waveguide. The signal mixing component includes at least a third ring resonator and a fourth ring resonator. The third ring resonator is coupled to the first waveguide and the fourth ring resonator is coupled to the second waveguide. Further, the third ring resonator and the fourth ring resonator are coupled to each other.

### FIELD

The subject matter described herein relates in general to designing and/or training an all-ring optical neural network (RONN).

### BACKGROUND

As more complex machine learning tasks have developed, computational power requirements have increased. However, current circuit solutions to meet the demands for higher computation power have had large device footprints, high driving voltages, large power consumption levels, and significant energy loss.

### SUMMARY

This section generally summarizes the disclosure and is not a comprehensive explanation of its full scope or all its features.

In one embodiment, a system for deep learning tasks using an optical neural network is disclosed. The system includes a ring-based optical neural network (RONN), also known as an all-ring optical neural network. The RONN includes a first waveguide and a second waveguide. The first waveguide is spaced from the second waveguide. The system includes a first phase tuning component, a second phase tuning component, and a signal mixing component. The first phase tuning component includes a first ring resonator coupled to the first waveguide. The second phase tuning component includes a second ring resonator coupled to the second waveguide. The signal mixing component includes at least a third ring resonator and a fourth ring resonator. The third ring resonator is coupled to the first waveguide and the fourth ring resonator is coupled to the second waveguide. The third ring resonator and the fourth ring resonator are coupled to each other.

In another embodiment, a system for deep learning tasks using an optical neural network is disclosed. The system includes a ring-based optical neural network (RONN), also known as an all-ring optical neural network. The RONN includes a waveguide and a non-linear activation component. The non-linear activation component includes a directional coupling component and an optical modulating component. The directional coupling component includes a first ring resonator coupled to the waveguide and the optical modulation component includes a second ring resonator coupled to the waveguide.

In another embodiment, a method for deep learning tasks using an optical neural network is disclosed. The method includes generating a characterization equation that describes a variation in a response of a component with respect to at least one tunable parameter of the component. The method includes training a ring-based optical neural network (RONN), also known as an all-ring optical neural network, for a task based on the characterization equation. The RONN includes the component. The method includes generating a value for the at least one tunable parameter based on the training and the task.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an example of a 2-layer all-ring optical neural network (RONN) system.

FIG. 2 is an example of a 3-port 1-layer all-ring optical neural network (RONN).

FIG. 3 is an example of a 2-port 1-layer all-ring optical neural network (RONN).

FIG. 4 is an example of a non-linear component.

FIG. 5 is an example of a method for training a RONN.

### DETAILED DESCRIPTION

Systems, methods, and other embodiments associated with training a ring-based optical neural network (RONN), also known as an all-ring optical neural network, are disclosed. More specifically, the systems, methods, and other embodiments are associated with training RONN to perform a specific task.

Computing platforms are used for machine learning purposes. Additionally, computing platforms can be customized to perform a specific task. The amount of computations performed on computing platforms continue to increase in an exponential manner. As such, the demand for computing resources has also increased. As an example, matrix multiplication function can lead to high energy and time consumption.

Accordingly, in one embodiment, the disclosed approach is a system that includes and trains an all-ring optical neural network (RONN). The RONN is a compact and energy efficient on-chip coherent photonic neural network with ring resonators. The RONN includes a linear portion and a non-linear portion. The linear portion includes tunable structures for matrix multiplication and the non-linear portion includes a programmable non-linear function. The RONN is scalable such that multiple linear and non-linear portions can be cascaded in series.

The RONN includes two or more waveguides. The wave guides are related to ports and encode information of one element of a vector. As such, a 2-port RONN has two waveguides and more generally, an N-port RONN has N waveguides. Optical signals travel along the waveguides. As an example, the optical signals are on the same wavelength making the RONN a coherent network. The waveguides are straight and parallel to each other. A portion of the waveguides is in the linear portion and a portion of the waveguides is in the non-linear portion. The linear portion includes a phase tuning component and a signal mixing component. The phase tuning component includes an all-pass single ring resonator and the signal mixing component includes serially coupled double ring resonators. The signal mixing component is located between two waveguides. In general, the signal mixing component may include two or more serially coupled ring resonators.

The non-linear portion varies the amplitude of the outgoing optical signal by increasing and decreasing the intensity of the outgoing optical signal. The non-linear portion may include a non-linear activation component which may increase the complexity and approximation power of the neural network. The non-linear activation component employs an optical modulator-based design.

The RONN may include micro-ring and/or ring resonators. The ring resonators may be of the same diameter and size. The distance between the ring resonators and the waveguides is set during fabrication of the RONN on a base substrate. Some of the micro-ring and/or ring resonators are tunable by adjusting the refractive index using thermo-optic and/or electro-optic methods. The base substrate may be thermally regulated by attaching to a thermoelectric cooler, vapor chamber, heat sink, or similar.

The RONN is developed using silicon photonics and other suitable material systems such as lithium niobate. As such, materials used for developing an on-chip integrated photonic circuit like the RONN include silicon, lithium niobate and silicon nitride. As a non-limiting example, the waveguide portion of the system disclosed herein may be fabricated on a silicon on insulator (SOI) substrate, although other substrates and material systems are conceivable. The RONN utilizes optics which provides high bandwidth, low energy consumption, relatively fast processing speeds in a compact or small form factor.

The system derives the physical models for each component and trains the RONN with backpropagation using a suitable method such as JAX. JAX is a python library made to boost machine learning using accelerators like tensor processing units (TPUs) or graphics processing units (GPUs). As an example, the system may train the RONN to function as a logic gate such as an exclusive OR gate. As another example, the system may train the RONN to function as a Modified National Institute of Standards and Technology (MNIST) database.

Current technologies such as systems with Mach-Zehnder interferometer (MZI) modulators have significantly larger footprints and can be quite lengthy. Further, past systems are only capable of performing the linear portion of a computation and are incapable of performing the non-linear portion of the computation. As such the past systems utilize MZI for the linear portion and a separate computing unit to generate the linear function. This means that the system requires converting an optical signal to a digital signal, using the separate computing unit to generate a non-linear function, and then converting the digital signal back to an optical signal. The conversion of optical signals to digital signals and back to optical signals requires additional resources (such as more power) that are not required by the disclosed invention.

The embodiments disclose herein present various advantages over current technologies. First, the embodiments can be implemented using optics and more specifically, ring resonators. As such, the RONN has a significantly smaller footprint (or form factor) than the prior art. As an example, there may be a ten-fold reduction in footprint area. Further, computation is executed at a relatively faster speed with significantly lower energy consumption. Second, the RONN includes waveguides that are straight and parallel which reduces bending loss and energy loss. As an example, the dynamic energy consumption for the non-linear portion may be reduced by a factor of ten. Third, the RONN uses optical signals throughout the network. As such, optical signal to digital signal conversion is not required so there is no signal conversion loss. Also, there is no need for detection between layers of the RONN so one pass is sufficient for achieving a result. Fourth and as previously mentioned, the RONN has a high computing efficiency, fast speed, low power consumption, and high energy efficiency. Fifth, the RONN is easier to design and is scalable.

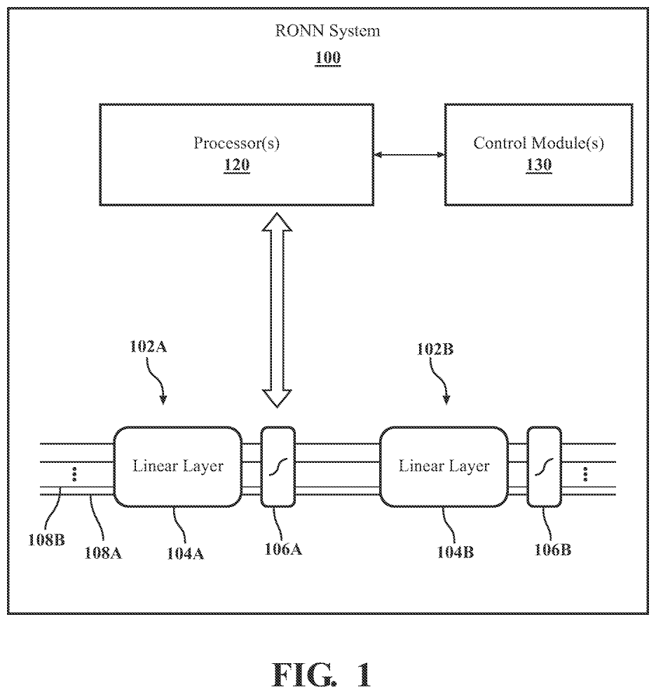

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

It will be appreciated that for simplicity and clarity of illustration, where appropriate. reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

With reference to FIG. 1, an example of a 2-layer all-ring optical neural network (RONN) system 100 is shown. The RONN system 100 can include various elements, which can be communicatively linked in any suitable form. As an example, the elements can be connected as shown in FIG. 1. Some of the possible elements of the RONN system 100 are shown in FIG. 1 and will now be described. It will be understood that it is not necessary for the RONN system 100 to have all of the elements shown in FIG. 1 or described herein. The RONN system 100 can have any combination of the various elements shown in FIG. 1. Further, the RONN system 100 can have additional elements to those shown in FIG. 1. In some arrangements, the RONN system 100 may not include one or more of the elements shown in FIG. 1.

The RONN system 100 can include one or more all-ring optical neural networks (RONN) 102A, 102B (collectively known as 102). Each RONN 102 may include a linear component 104A. 104B (collectively known as 104) and a non-linear component 106A, 106B (collectively known as 106). The RONN 102 may include tunable elements in the linear component 104 and/or the non-linear component 106. The linear component 104 may include a phase tuning component and/or a signal mixing component. The non-linear component 106 may include a directional coupler and/or an optical modulator. The phase tuning component, the signal mixing component, the directional coupler, and/or the optical modulator may include tunable elements. As such, the phase tuning component, the signal mixing component, the directional coupler, and/or the optical modulator may include tunable parameters. The RONN 102 may include a first waveguide 108A and a second waveguide 108B. The first waveguide 108A may be spaced from and/or parallel to the second waveguide 108B. More generally, the RONN 102 may include a plurality of waveguides including the first waveguide 108A and the second waveguide 108B. Two or more RONNs 102 may be cascaded such that output of a first RONN 102A is input of a second RONN 102B. The RONN 102 can be of any suitable material such as silicon, lithium niobate and silicon nitride. As a non-limiting example, the waveguide portion of the RONN 102 disclosed herein may be fabricated on a silicon on insulator (SOI) substrate, although other substrates and material systems are conceivable.

The RONN system 100 can include one or more processors 120. “Processor” means any component or group of components that are configured to execute any of the processes described herein or any form of instructions to carry out such processes or cause such processes to be performed. The processor(s) 120 can be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 120 can include at least one hardware circuit (e.g., an integrated circuit) configured to carry out instructions contained in program code. In arrangements in which there is a plurality of processors 120, such processor(s) 120 can work independently from each other or one or more processor(s) 120 can work in combination with each other.

The RONN system 100 can include one or more modules, which will be described herein. The modules can be implemented as computer readable program code that, when executed by a processor, implement one or more of the various processes described herein. One or more of the modules can be a component of the processor(s) 120, or one or more of the modules can be executed on and/or distributed among other processing systems to which the processor(s) 120 is operatively connected. The modules can include instructions (e.g., program logic) executable by one or more processor(s) 120. Alternatively, or in addition, one or more data stores may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The RONN system 100 can include one or more control modules 130. The control module(s) 130 can be configured to train the RONN 102 by adjusting the tunable elements in the linear components and/or the non-linear components so as to achieve a desired performance objective. The control module can be configured to generate a characterization equation that describes a variation in a response of a component with respect to at least one tunable parameter of the component. As an example, the component may be a linear component. In such an example, the linear component may include a phase tuning component and/or a signal mixing component. As another example, the component may be a non-linear component. In such an example, the non-linear component may include a directional coupler and/or an optical modulator. The control module can be further configured to train the RONN 102 for a task based on the characterization equation. The control module may generate a value for a tunable parameter based on the training and the task and may assign the value to the tunable parameter.

The control module can be configured to generate a first characterization equation that describes a variation in a response of a linear component with respect to at least one tunable parameter of the linear component and can be further configured to generate a second characterization equation that describes a variation in a response of a non-linear component with respect to at least one tunable parameter of the non-linear component. The control module can be further configured to train the ring-based optical neural network (RONN) for a task based on the first and second characterization equations. The control module may generate a first value for the tunable parameter of the linear component and a second value for the tunable parameter of the non-linear component based on the training and the task and may assign the first value to the tunable parameter of the linear component and the second value to the tunable parameter of the non-linear component.

In more detail, the control module can be configured to perform a component analysis on each tunable element within the linear and/or non-linear components. As such, the control module may perform a component analysis on a tunable element to characterize the response of the tunable element to tunable parameters such as temperature, voltage, and/or force. The control module may then generate a response function based on the characterization. The control module may generate a derivative of the response function to the tunable parameters. The control module may then generate a characterization equation that describes a variation of the response function with respect to the tunable parameters. In other words, the control module may generate a characterization equation for each component, both the linear and the non-linear components.

The control module 130 can be configured to train the RONN 102 based on the characterization equation for each component. As such, the control module 130 may generate optimization algorithms for the RONN 102 based on the characterization equation of each component in the RONN. The control module may then apply the trained tunable parameters to the components and the corresponding physical devices.

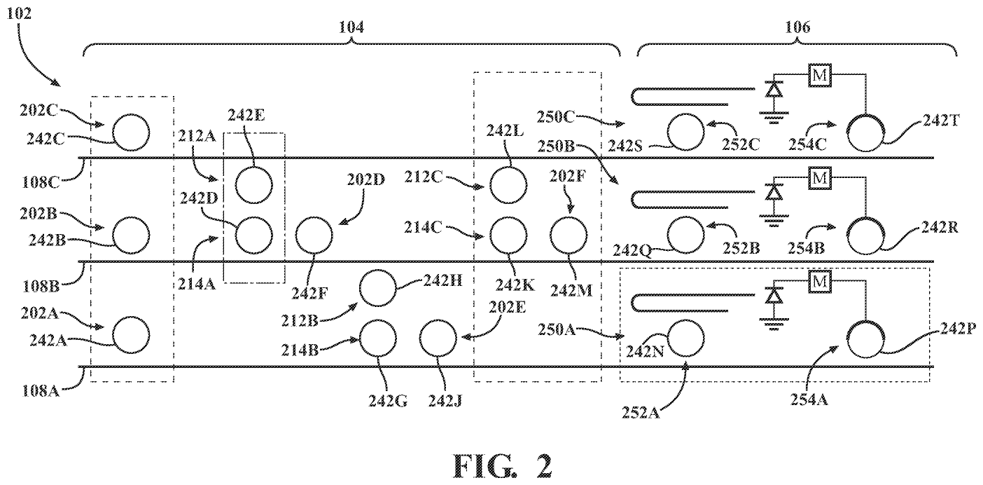

With reference to FIG. 2, an example of a 3-port 1-layer all-ring optical neural network (RONN) 102 is shown. The RONN 102 may include a plurality of waveguides 108 including a first waveguide 108A, a second waveguide 108B, and a third waveguide 108C. Each of the first, second, and third waveguides 108 may be spaced from each other as shown. The RONN 102 may include a linear component 104 and a non-linear component 106.

The linear component 104 of the RONN 102 includes a first phase tuning component 202A, a second phase tuning component 202B, and a third phase tuning component 202C. The first phase tuning component 202A, the second phase tuning component 202B, and the third phase tuning component 202C are also known as global phase tuning components. The global phase tuning component adjusts the phase of a signal arriving at a port (i.e., into the waveguide). The first phase tuning component 202A includes a first ring resonator 242A coupled to the first waveguide 108A, the second phase tuning component 202B includes a second ring resonator 242B coupled to the second waveguide 108B, and the third phase tuning component 202C includes a third ring resonator 242C coupled to the third waveguide 108C.

The linear component 104 of the RONN 102 further includes a first signal mixing component 212A, a second signal mixing component 212B, a third signal mixing component 212C, a fourth phase tuning component 202D, a fifth phase tuning component 202E, and a sixth phase tuning component 202F. The first signal mixing component 212A includes a first set of serially coupled double ring resonators 214A. The first set of serially coupled double ring resonators 214A includes a fourth ring resonator 242D and a fifth ring resonator 242E. The fourth ring resonator 242D is coupled to the second waveguide 108B and the fifth ring resonator 242E is coupled to the third waveguide 108C, and the fourth ring resonator 242D and the fifth ring resonator 242E are coupled to each other. The fourth phase tuning component 202D includes a sixth ring resonator 242F coupled to the second waveguide 108B.

The second signal mixing component 212B includes a second set of serially coupled double ring resonators 214B. The second set of serially coupled double ring resonators 214B includes a seventh ring resonator 242G and an eighth ring resonator 242H. The seventh ring resonator 242G is coupled to the first waveguide 108A and the eighth ring resonator 242H is coupled to the second waveguide 108B, and the seventh ring resonator 242G and the eighth ring resonator 242H are coupled to each other. The fifth phase tuning component 202E includes a ninth ring resonator 242J coupled to the first waveguide 108A.

The third signal mixing component 212C includes a third set of serially coupled double ring resonators 214C. The third set of serially coupled double ring resonators 214C includes a tenth ring resonator 242K and an eleventh ring resonator 242L. The tenth ring resonator 242K is coupled to the second waveguide 108B and the eleventh ring resonator 242L is coupled to the third waveguide 108C, and the tenth ring resonator 242K and the eleventh ring resonator 242L are coupled to each other. The sixth phase tuning component 202F includes a twelfth ring resonator 242M coupled to the second waveguide 108B.

As shown in FIG. 2, multiple optical signals travel through the RONN 102. A first optical signal is travelling on the first waveguide 108A, a second optical signal is traveling on the second waveguide 108B, and a third optical signal is travelling on the third waveguide 108C. The first phase tuning component adjusts the phase of the first optical signal, the second phase tuning component adjusts the phase of the second optical signal, and the third phase tuning component adjusts the phase of the third optical signal so as to synchronize the phases of the first, second, and third optical signals. For explanation purposes, the phase-adjusted first, second, and third optical signals are referred to as first, second, and third 1^{st} stage optical signals respectively.

The first signal mixing component 212A receives the second and third 1^{st} stage optical signals and combines the second and third 1^{st} stage optical signals into a first set of mixed optical signals using the first set of serially coupled double ring resonators 214A. The first set of mixed optical signals is output on the second and third waveguides 108B, 108C. The first set of mixed optical signals includes a first 2^{nd} stage optical signal and a second 2^{nd} stage optical signal. The first 2^{nd} stage optical signal is output on the second waveguide 108B and the second 2^{nd} stage optical signal is output on the third waveguide 108C. In general, serially coupled double ring resonators can couple optical signals from two different waveguides. In this example, the first set of serially coupled double ring resonators 214A couple the second and third 1^{st} stage optical signals from the second and third waveguides 108B, 108C respectively into the first set of mixed optical signals. The fourth phase tuning component 202D adjusts the phase of the first 2^{nd} stage optical signal. As an example, the fourth phase tuning component 202D may adjust the phase of the first 2^{nd} stage optical signal such that the first 2^{nd} stage optical signal is in sync with the first 1^{st} stage optical signal on the first waveguide 108A and the second 2^{nd} stage optical signal on the third waveguide 108C.

The second signal mixing component 212B receives the first 2^{nd} stage optical signal on the second waveguide 108B and the first 1^{st} stage optical signal on the first waveguide 108A and combines the first 2^{nd} stage optical signal and the first 1^{st} stage optical signal into a second set of mixed optical signals using the second set of serially coupled double ring resonators 214B. One of the second set of mixed optical signals is the first 3^{rd} stage optical signal and is output on the first waveguide 108A. The other of the second set of mixed optical signals is the second 3^{rd} stage optical signal and is output on the second waveguide 108B. The fifth phase tuning component 202E adjusts the phase of the first 3^{rd} stage optical signal. Also as an example, the fifth phase tuning component 202E may adjust the phase of the first 3^{rd} stage optical signal such that the first 3^{rd} stage optical signal on the first waveguide 108A is in sync with the second 3^{rd} stage optical signal on the second waveguide 108B and the second 2^{nd} stage optical signal on the third waveguide 108C.

The third signal mixing component 212C receives the second 3^{rd} stage optical signal on the second waveguide 108B and the second 2^{nd} stage optical signal on the third waveguide 108C and combines the second 3^{rd} stage optical signal and the second 2^{nd} stage optical signal into a third set of mixed optical signals using the third set of serially coupled double ring resonators 214C. One of the third set of mixed optical signals is the first 4^{th} stage optical signal and is output on the second waveguide 108B. The other of the second set of mixed optical signals is the second 4^{th} stage optical signal and is output on the third waveguide 108C. The sixth phase tuning component 202F adjusts the phase of the first 4^{th} stage optical signal. Also as an example, the sixth phase tuning component 202F may adjust the phase of the first 4^{th} stage optical signal such that the first 4^{th} stage optical signal on the second waveguide 108B is in sync with the second 4^{th} stage optical signal on the third waveguide 108C and the first 3^{rd} stage optical signal on the first waveguide 108A.

The non-linear component 106 of the RONN 102 includes a first non-linear activation component 250A, a second non-linear activation component 250B, and a third non-linear activation component 250C. The first non-linear activation component 250A may include a first directional coupling component 252A and a first optical modulating component 254A. The first directional coupling component 252A may include a thirteenth ring resonator 242N and the first optical modulating component 254A may include a fourteenth ring resonator 242P. The second non-linear activation component 250B may include a second directional coupling component 252B and a second optical modulating component 254B. The second directional coupling component 252B may include a fifteenth ring resonator 242Q and the second optical modulating component 254B may include a sixteenth ring resonator 242R. The third non-linear activation component 250C may include a third directional coupling component 252C and a third optical modulating component 254C. The third directional coupling component 252C may include a seventeenth ring resonator 242S and the second optical modulating component may include an eighteenth ring resonator 242T. Each of the thirteenth through to eighteenth ring resonators, 242N, 242P, 242Q, 242R, 242S, 242T may be tunable.

As an example and as previously mentioned, the first directional coupling component 252A taps a relatively small portion of the first 3^{rd} stage optical signal on the first waveguide 108A. leaving a larger portion of the first 3^{rd} stage optical signal on the first waveguide 108A. A photodetector detects the signal intensity of the relatively small portion of the first 3^{rd} stage optical signal and converts the relatively small portion of the first 3^{rd} stage optical signal to an electric signal based on the signal intensity. The first optical modulation component 254A uses the electric signal which is also a digital signal as a modulating signal. The first optical modulation component 254A modulates the larger portion of the first 3^{rd} stage optical signal based on the electric signal such that the outgoing optical signal from the first waveguide 108A varies in amplitude and/or intensity based on the electric signal. Similar to the manner in which the first non-linear activation component 250A processes the first 3^{rd} stage optical signal on the first waveguide 108A, the second non-linear activation component 250B processes the first 4^{th} stage optical signal on the second waveguide 108B and the third non-linear activation component 250C processes the second 4^{th} stage optical signal on the third waveguide 108C. As such, the first, second, and third non-linear activation components 250A, 250B, 250C may adjust the amplitude and/or phase of the first 3^{rd} stage optical signal on the first waveguide 108A, first 4^{th} stage optical signal on the second waveguide 108B, and the second 4^{th} stage optical signal on the third waveguide 108C respectively.

In general, an N-port RONN may include a linear portion and a non-linear portion. In the linear portion, the N-port RONN may include N*(N−1)/2 signal mixing components (i.e., coupled double ring modulators), N*(N−1)/2 phase tuning components (i.e., one ring modulators), and N global phase tuning components (i.e., one ring modulators). In the non-linear portion, the N-port RONN may include N beam splitters (i.e., one ring modulators) and N one ring modulators that are each critically coupled to one of the N waveguides.

As previously mentioned, the RONN is scalable such that multiple linear and non-linear portions can be cascaded in series. As such, a RONN may have multiple layers. As an example, a deep RONN with M layers may include M linear layers and M non-linear layers. Also, as an example, Clements mesh may be utilized to build a matrix multiplication linear layer.

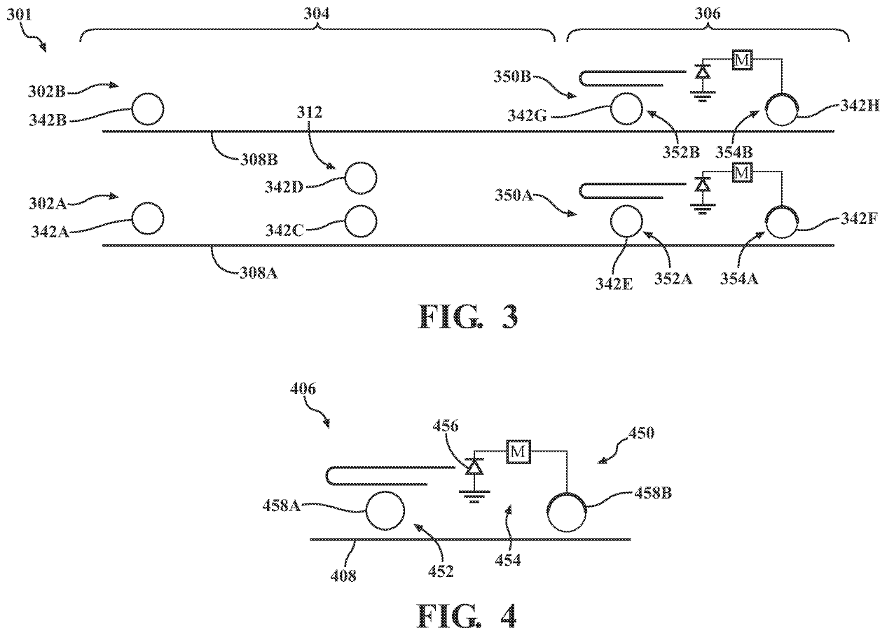

With reference to FIG. 3, another example of a 2-port 1-layer RONN 301 is shown. The RONN 301 includes linear component 304, similar to the linear component 104 shown in FIGS. 1-2. In one embodiment and as shown, the linear component 304 includes a first phase tuning component 302A, a second phase tuning component 302B, and a signal mixing component 312. The first phase tuning component 302A includes a first ring resonator 342A coupled to the first waveguide 308A and the second phase tuning component 302B includes a second ring resonator 342B coupled to the second waveguide 308B. The degree of coupling between a ring resonator and a waveguide can be adjusted based on a distance between the ring resonator and the waveguide. The distance is fixed during fabrication of the RONN 301 on a base substrate. Each of the first ring resonator 342A and the second ring resonator 342B may be an all-pass single ring resonator operating as a phase tuning component. As such, the first ring resonator 342A may adjust a phase of the first optical signal and the second ring resonator 342B may adjust a phase of the second optical signal. The first ring resonator 342A and the second ring resonator 342B may be tunable. In such a case, the RONN system 100 may tune the first ring resonator 342A and/or the second ring resonator 342B by adjusting the refractive index of the first ring resonator 342A and/or the second ring resonator 342B using thermo-optic and/or electro-optic methods. In the case of using thermo-optic methods, thermal response may be further passively tuned by selectively creating etched trenches (not shown) in the device substrate around preferred portions of the waveguide and/or ring resonator structures during RONN fabrication.

In another embodiment, the linear component 304 may include the signal mixing component without the phase tuning components 302A, 302B. The signal mixing component 312 includes at least a third ring resonator 342C and a fourth ring resonator 342D. The third ring resonator 342C is coupled to the first waveguide 308A and the fourth ring resonator 342D is coupled to the second waveguide 308B. The third ring resonator 342C and the fourth ring resonator 342D are coupled to each other. More specifically, the third ring resonator 342C and the fourth ring resonator 342D are serially coupled double ring resonators operating as a signal mixing component between the first waveguide 308A and the second waveguide 308B.

The RONN 301 includes non-linear component 306, similar to the non-linear component 106 shown in FIGS. 1-2. The non-linear component 306 may include a first non-linear activation component 350A and a second non-linear activation component 350B. The first non-linear activation component 350A includes a first directional coupling component 352A and a first optical modulating component 354A. The first directional coupling component 352A includes a fifth ring resonator 342E and the first optical modulating component 354A includes a sixth ring resonator 342F. The second non-linear activation component 350B includes a second directional coupling component 352B and a second optical modulating component 354B. The second directional coupling component 352B includes a seventh ring resonator 342G and the second optical modulating component 354B includes an eighth ring resonator 342H. At least one of the fifth ring resonator 342E and the sixth ring resonator 342F is tunable. Also, at least one of the seventh ring resonator 342G and the eighth ring resonator 342H is tunable.

With reference to FIG. 4, another example of a non-linear component 406, similar to the linear component 106 shown in FIGS. 1-2. The non-linear component 406 may include a non-linear activation component 450. As such, the non-linear component 406 may include a waveguide 408 and the non-linear activation component 450. The non-linear activation component 450 may include a directional coupling component 452 and an optical modulating component 454. The non-linear activation component 450 may further include a photodetector 456. The directional coupling component 452 may include a first ring resonator 458A coupled to the waveguide 408, and the optical modulation component 454 may include a second ring resonator 458B coupled to the waveguide 408. The first ring resonator 458A and the second ring resonator 458B may be tunable. The directional coupling component 452 may act as a beam splitter and tap off a small portion of the optical signal from the waveguide 408, with a larger portion of the optical signal remaining in the waveguide 408. The photodetector 456 may detect the signal intensity of the small portion of the optical signal and convert the optical signal to an electric signal based on the signal intensity. The optical modulation component 454 uses the electric signal which is also a digital signal as a modulating signal. The optical modulation component 454 modulates the larger portion of the optical signal based on the electric signal such that the outgoing optical signal from the waveguide 408 may vary in amplitude and/or intensity.

Now that the various potential systems, devices, elements and/or components of the RONN system 100 have been described, various methods will now be described. Various possible steps of such methods will now be described. The methods described may be applicable to the arrangements described above in relation to FIGS. 1-4, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

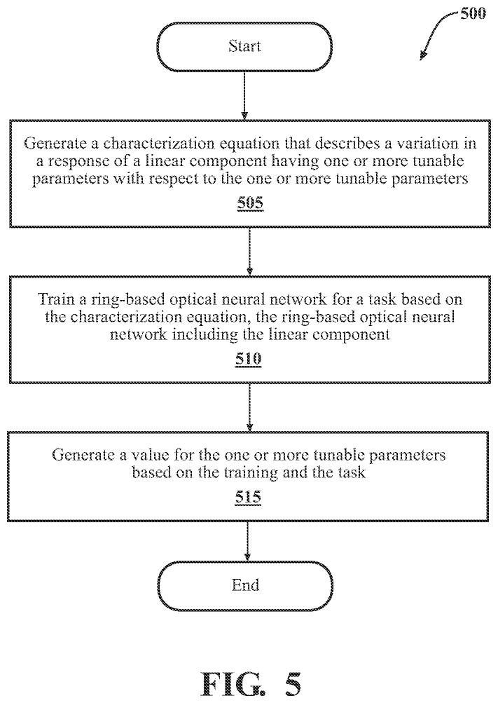

Referring now to FIG. 5, an example of a method 500 for training an all-ring optical neural network (RONN) 102 is shown. The method 500 will be discussed with respect to the RONN 102 of FIG. 1. However, it should be appreciated that the method 500 is not limited to being implemented only within the RONN system 100 but is instead one example of a system that may implement the method 500.

At 505, the control module 130 may cause the processor 120 to generate a characterization equation that describes a variation in a response of a linear and/or a non-linear component 104, 106 having one or more tunable parameters with respect to the one or more tunable parameters. The linear component and/or non-linear component 104, 106 may include one or more tunable elements. As previously mentioned, the control module 130 can be configured to perform a component analysis on each tunable element within the linear and/or non-linear components 104, 106. As such, the control module 130 may perform a component analysis on the tunable element to characterize the response of the tunable element to tunable parameters and may then generate a response function for the linear and/or non-linear components 104, 106 based on the characterization. The control module 130 may then generate a characterization equation that describes a variation of the response function with respect to the tunable parameters.

At 510, the control module 130 may, as previously mentioned, cause the processor 120 to train the RONN 102, which includes the linear and/or the non-linear components 104, 106 for a task based on the characterization equation.

At 515, the control module 130 may cause the processor 120 to generate a value for the tunable parameter(s) of the linear and/or the non-linear component(s) 104, 106 based on the training and the task. The control module 130 may assign the value to the tunable parameter(s).

The method 500 can end. Alternatively, the method 500 can return to block 505 or some other block.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances. The term “operatively connected,” as used throughout this description, can include direct or indirect connections, including connections without direct physical contact.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A system, comprising:
a first waveguide and a second waveguide, the first waveguide being spaced from the second waveguide;
a first phase tuning component, the first phase tuning component including a first ring resonator coupled to the first waveguide;
a second phase tuning component, the second phase tuning component including a second ring resonator coupled to the second waveguide; and
a signal mixing component, the signal mixing component including at least a third ring resonator and a fourth ring resonator, the third ring resonator being coupled to the first waveguide, the fourth ring resonator being coupled to the second waveguide, and the third ring resonator and the fourth ring resonator being coupled to each other.

2. The system of claim 1, wherein the first waveguide is parallel to the second waveguide.

3. The system of claim 1, wherein the first ring resonator is tunable.

4. The system of claim 1, wherein the second ring resonator is tunable.

5. The system of claim 1, further comprising:
a first non-linear activation component, the first non-linear activation component including a first directional coupling component and a first optical modulating component, the first directional coupling component including a fifth ring resonator and the first optical modulating component including a sixth ring resonator; and
a second non-linear activation component, the second non-linear activation component including a second directional coupling component and a second optical modulating component, the second directional coupling component including a seventh ring resonator and the second optical modulating component including an eighth ring resonator.

6. The system of claim 5, wherein at least one of the fifth ring resonator and the sixth ring resonator is tunable.

7. The system of claim 5, wherein at least one of the seventh ring resonator, and the eighth ring resonator is tunable.

8. A system, comprising:
a waveguide; and
a non-linear activation component, the non-linear activation component including:
a directional coupling component, the directional coupling component including a first ring resonator coupled to the waveguide; and
an optical modulating component, the optical modulation component including a second ring resonator coupled to the waveguide.

9. The system of claim 8, wherein the first ring resonator is tunable.

10. The system of claim 8, wherein the second ring resonator is tunable.

11. A method, comprising:
generating a characterization equation that describes a variation in a response of a component with respect to at least one tunable parameter of the component;
training a ring-based optical neural network for a task based on the characterization equation, the ring-based optical neural network including the component; and
generating a value for the at least one tunable parameter based on the training and the task.

12. The method of claim 11, further comprising:
assigning the value to the at least one tunable parameter.

13. The method of claim 11, wherein the component is a linear component.

14. The method of claim 13, wherein the linear component includes a phase tuning component.

15. The method of claim 13, wherein the linear component includes a signal mixing component.

16. The method of claim 11, wherein the component is a non-linear component.

17. The method of claim 16, wherein the non-linear component includes a directional coupler.

18. The method of claim 16, wherein the non-linear component includes an optical modulator.

19. The method of claim 11, wherein the ring-based optical neural network includes a first waveguide and a second waveguide, the first waveguide being spaced from the second waveguide.

20. The method of claim 19, wherein the first waveguide is parallel to the second waveguide.
